(19) United States
(12) Patent Application Publication
(10) Pub. No.: US 2005/0003248 A1
(43) Pub. Date: Jan. 6, 2005

(54) Fuel gas production apparatus and fuel cell system

(75) Inventors: Kazuhito Matsuda, Shioya-gun (JP); Satoshi Hanai, Haga-gun (JP); Masako Takayama, Nerima-ku (JP)

Correspondence Address: LAHIVE & COCKFIELD, LLP., 28 STATE STREET, BOSTON, MA, 02109, US

(73) Assignee: Honda Motor Co., Ltd., Tokyo (JP)

(21) Appl. No.: 10/800,230

(22) Filed: Mar. 12, 2004

(30) Foreign Application Priority Data
Mar. 13, 2003 (JP) 2003-067703

(51) Int. Cl. H01M 8/06; B01J 8/02

(52) U.S. Cl. 429/19; 429/20; 422/193

(57) ABSTRACT

A fuel gas production apparatus includes a reforming mechanism, a cooling mechanism connected an outlet side of the reforming mechanism and a PSA mechanism directly connected to the reforming mechanism through the cooling mechanism. The reforming mechanism uses an auto-thermal reforming system for reforming a fuel to obtain a reformed gas. The cooling mechanism cools the reformed gas to a predetermined temperature. After the reformed gas is cooled by the cooling mechanism, the PSA mechanism removes impurities from the reformed gas to produce a hydrogen-rich pure fuel gas.

### BACKGROUND OF THE INVENTION

1. Field of the Invention

The present invention relates to a fuel gas production apparatus for reforming a hydrogen-containing fuel into a reformed gas to produce a hydrogen-rich fuel gas. Further, the present invention relates to a fuel cell system including the fuel gas production apparatus.

2. Description of the Related Art

For example, a solid polymer electrolyte fuel cell employs a membrane electrode assembly (MEA) which includes two electrodes (anode and cathode), and an electrolyte membrane interposed between the electrodes. The electrolyte membrane is a polymer ion exchange membrane. The membrane electrode assembly is interposed between a pair of separators. The membrane electrode assembly and the separators make up a unit cell for generating electricity. A plurality of the unit cells are stacked together to form a fuel cell stack, and the fuel cell stack can be used widely in various applications. Typically, the fuel cell stack is mounted on a vehicle.

In the unit cell, a fuel gas such as a gas chiefly containing hydrogen (hydrogen-containing gas) is supplied to the anode. The catalyst of the anode induces a chemical reaction of the fuel gas to split the hydrogen molecule into hydrogen ions (protons) and electrons. The hydrogen ions move toward the cathode through the electrolyte membrane, and the electrons flow through an external circuit to the cathode, creating a DC electric current.

Conventionally, hydrocarbon fuels such as natural gas or hydrogen-containing fuels such as alcohols (e.g. methanol) are refined to produce the hydrogen-containing gas as the fuel gas, and the hydrogen-containing gas is supplied to the fuel cell stack. For example, Japanese laid-open patent publication No. 8-225302 discloses a system 1 of producing a hydrogen-containing gas as shown in FIG. 3. The production system 1 includes a desulfurization device 2, a high temperature reformer 3, a high temperature shift reactor 4, and a PSA (Pressure Swing Adsorption) device 5.

The desulfurization device 2 uses hydrodesulfurization catalyst such as a cobalt molybdenum (CoMo) catalyst or an adsorption catalyst such as zinc oxide for removing sulfer substantially from a raw material (petroleum hydrocarbon). After sulfer is removed from the material, the material is reformed by the high temperature reformer 3. Specifically, a reaction tube is filled with a nickel based catalyst, and the reaction tube is heated externally to induce steam reforming reaction at a high temperature. In this manner, the reformed gas is refined to have a high hydrogen-concentration.

The high temperature shift reactor 4 uses a high temperature shift catalyst such as iron oxide to induce shift reaction of carbon monoxide (CO) to produce hydrogen. Thus, a hydrogen-rich mixed gas is obtained. Further, the PSA device 5 removes CO₂, methane, and CO from the mixed gas to produce a highly pure hydrogen-containing gas.

The PAS device 5 has a plurality of adsorption towers filed with adsorbent material for selectively absorbing impurities (components other than hydrogen) under high pressure, and releasing the absorbed components under low pressure. The impurities in the mixed gas are absorbed by the adsorption towers under high pressure leaving the hydrogen in the gas container, and the hydrogen is removed as the purified hydrogen product. After the hydrogen is removed, the impurities are released from the adsorption towers under low pressure. After the waste gas containing the impurities is flushed (purged) from the PSA device 5, the mixed gas is supplied to the PSA device 5 again to start another hydrogen production cycle. The series of steps are repeated by the pressure swing operation (alternately pressurizing and depressurizing the gas container).

Among the gas components in the mixed gas, CO is not easily absorbed by the adsorption towers. Therefore, in order to produce a compact PSA device 5 at a low cost, the high temperature shift reactor 4 is provided at an upstream side (inlet side) of the PSA device 5, and the mixed gas is supplied to the PSA device 5 after the amount (concentration) of CO in the reformed gas is reduced substantially by the high temperature shift reactor 4.

However, the CO shifting reaction is slow in comparison with other reactions such as reforming reactions in the production system 1. Consequently, the size of the high temperature shift reactor 4 needs to be large in comparison with the other devices in the production system 1. Consequently, the overall size of the production system 1 is considerably large.

The CO shift catalyst is not durable in contrast with the other catalyst such as a reforming catalyst. The overall durability of the production system 1 is subject to the constraints of the durability (service life) of the CO shift catalyst. As a result, the production system 1 can not be used continuously for a long period of time.

Though the CO shift catalyst generates thermal energy when oxidation and reduction are repeatedly performed. Inert gas such as nitrogen gas or vapor is required for heating at the time of starting the production system. Further, the inert gas also used for purging the combustible waste gas. The CO shift catalyst may be deteriorated undesirably when oxidation and reduction are repeatedly performed. Thus, combustible air is not supplied directly to the high temperature shift reactor 4. Therefore, it is difficult to reduce the time and energy for starting the production of the fuel gas.

### SUMMARY OF THE INVENTION

A main object of the present invention is to provide a fuel gas production apparatus with a compact and simple structure in which the desired reforming reaction can be started in a short period of time, and the reformed gas is refined to produce a hydrogen-rich fuel gas efficiently and to provide a fuel cell system using the fuel gas production apparatus

According to the present invention, a fuel gas production apparatus for reforming a hydrogen-containing fuel to produce a hydrogen-rich fuel gas comprises a reforming mechanism for reforming the hydrogen-containing fuel to obtain a reformed gas, and a PSA mechanism directly connected to the reforming mechanism for removing impurities from the reformed gas to refine the reformed gas into the fuel gas.

The term “hydrogen-containing fuel” herein means any material which contains hydrogen element, such as hydrocarbon or alcohol. The expression “directly connected” herein means, no mechanisms for inducing chemical reaction are provided between the two components. For example, mechanisms which do not induce chemical reaction such as a cooling mechanism or a compression mechanism may be provided between the reforming mechanism and the PSA mechanism.

A fuel, and steam, and oxygen are supplied to the reforming mechanism so that oxidation reaction and fuel reforming reaction can be carried out simultaneously.

For example, methane is used as the fuel supplied to the reforming mechanism. In this case, the following reactions occur simultaneously.
CH₄+2O₂→CO₂+2H₂O (exothermic reaction) (1)
CH₄+2H₂O→CO₂+4H (endothermic reaction) (2)

In contrast, in the usual steam reforming system, only the endothermic reaction occurs. Therefore, an external heating mechanism is required. The external heating mechanism is not used in the auto-thermal reforming. In contrast to the steam reforming system, the auto thermal reforming system is small, and requires less time for warming up the system to start production of the fuel gas.

The reforming mechanism using the auto thermal reforming system is capable of effectively reducing the CO concentration in contrast to the reforming mechanism using the steam reforming system. Even though the CO shift reaction of the reformed gas is not carried out, it is possible to use a small PSA mechanism. Consequently, no high temperature shift reactor is required. With the simple and compact PSA mechanism, the desired reforming reaction can be carried out effectively, and the hydrogen-rich fuel gas can be produced efficiently.

The reformed gas has a considerably high temperature. The cooling mechanism cools the hot reformed gas by heat exchange to a predetermined low temperature. The relatively large thermal energy (waste heat) generated by the heat exchange is utilized for cogeneration.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a diagram schematically showing a fuel cell system including a fuel gas production apparatus according to an embodiment of the present invention;

FIG. 2 is a diagram showing main components of the fuel gas production apparatus; and

FIG. 3 is a diagram schematically showing a system disclosed in Japanese laid-open patent publication No. 8-225302.

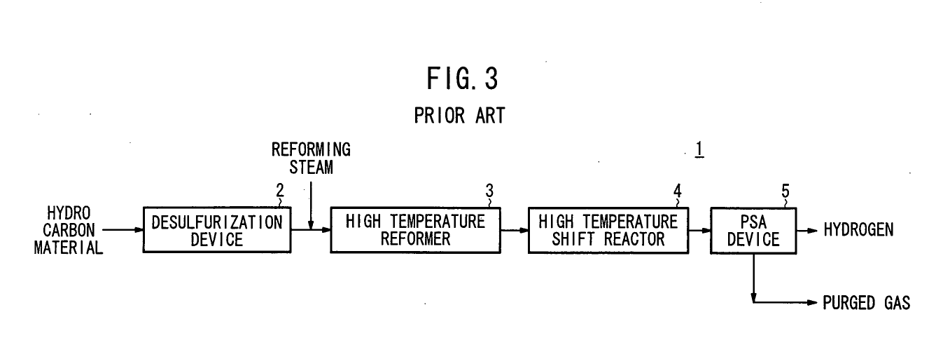

### DESCRIPTION OF THE PREFERRED EMBODIMENTS

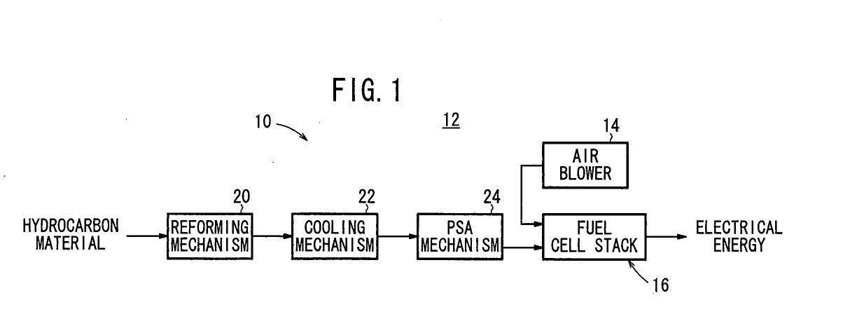

FIG. 1 is a diagram schematically showing a fuel cell system 12 including a fuel gas production apparatus 10 according to an embodiment of the present invention.

The fuel cell system 12 includes a fuel gas production apparatus 10 and a fuel cell stack 16. The fuel gas production apparatus 10 reforms a hydrogen-containing fuel, e.g., a fuel including hydrocarbon such as methane or propane to obtain a hydrogen-rich reformed gas, and refines the hydrogen rich reformed gas to produce a pure fuel gas. The fuel gas produced in the fuel gas production apparatus 10 is supplied to the fuel cell stack 16. Further, an oxygen-containing gas such as air is supplied to the fuel cell stack 16 by an air blower 14. Hydrogen in the fuel gas and oxygen in the oxygen-containing gas are consumed in the electrochemical reactions in the fuel cell stack 16 for generating electricity. In the embodiment of the present invention, methane is used as the hydrocarbon.

The fuel gas production apparatus 10 includes a reforming mechanism 20, a cooling mechanism 22 connected an outlet side of the reforming mechanism 20 and a PSA mechanism 24 directly connected to the reforming mechanism 20 through the cooling mechanism 22. The reforming mechanism 20 uses an auto-thermal reforming system for reforming a fuel to obtain a reformed gas. The cooling mechanism 22 cools the reformed gas to a predetermined temperature. After the reformed gas is cooled by the cooling mechanism 22, the PSA mechanism 24 removes impurities from the reformed gas to produce a hydrogen-rich pure fuel gas. No mechanisms for inducing chemical reaction are provided between the reforming mechanism 20 and the PSA mechanism 24. However, a compression mechanism (not shown) may be provided between the reforming mechanism 20 and the PSA in addition to the cooling mechanism 22, for example.

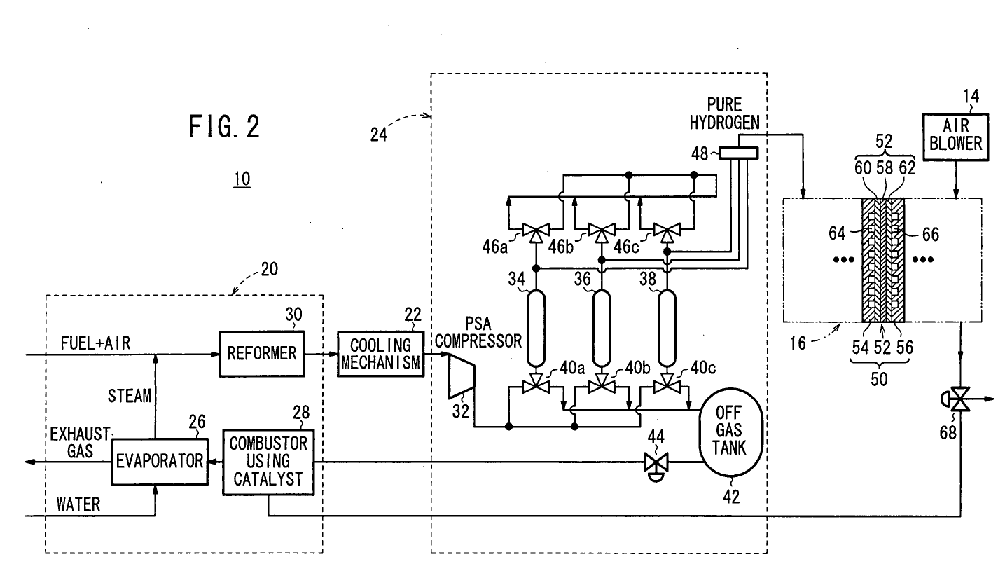

As shown in FIG. 2, the reforming mechanism 20 includes an evaporator 26 for evaporating water into water vapor (steam), a combustor 28 using a catalyst for heat generation and supplying the heat energy to the evaporator 26. Further, the reforming mechanism 20 includes a reformer 30 for reforming the mixed gas of water vapor (steam) from the combustor 28, the fuel, and the air to obtain a reformed gas containing hydrogen gas.

The PSA mechanism 24 includes a tri-tower pressure swing adsorption apparatus, for example. The pressure swing adsorption apparatus has adsorption towers 34, 36, 38, which are connectable to a PSA compressor 32. Each of the adsorption towers 34, 36, 38 has first and second ports. Valves 40a through 40c are connected to the first ports of the adsorption towers 34 through 38, respectively so that the adsorption towers 34 through 38 can be selectively connected to an off-gas tank 42. The off-gas tank 42 is connected to the combustor 28 through a flow rate control valve 44.

Valves 46a through 46c are connected to the second ports of adsorption towers 34 through 38, and the adsorption tower 34 through 38 are selectively connected to a fuel gas flow field 64 in the fuel cell stack 16 as described later through a valve 48.

The fuel cell stack 16 is formed by stacking a plurality of fuel cells 50. Each of the fuel cells 50 includes a membrane electrode assembly 52, and first and second separators 54, 56 sandwiching the membrane electrode assembly 52. The membrane electrode assembly 52 includes an anode 60, a cathode 62, and a solid polymer electrolyte membrane 58 interposed between the anode 60 and the cathode 62.

The first separator 54 has the fuel gas flow field 64 for supplying a fuel gas to the anode 60. The second separator 56 has an oxygen-containing gas flow field 66 for supplying an oxygen-containing gas such as air to the cathode 62. The air is supplied to an inlet of the oxygen-containing gas flow field 66 through the air blower 14. An outlet of the oxygen-containing gas flow field 66 is connectable to the combustor 28 through a valve 68. A coolant flow field is formed between the first and second separators 54, 56 as necessary.

Next, operation of the fuel gas production apparatus 10 and the fuel cell system 12 will be described.

As shown in FIG. 2, water is supplied to the evaporator 26. A high temperature combustion gas produced in the combustor 28 is supplied to the evaporator 26. The heat energy of the high temperature combustion gas is used to vaporize water into water vapor. The water vapor (steam) is mixed into the fuel containing methane and the air, and supplied to the reformer 30.

The reformer 30 induces oxidation reaction CH₄+2O₂→CO₂+2H₂O (exothermic reaction) and fuel reforming reaction CH₄+2H₂O→CO₂ +4H (exothermic reaction) simultaneously.

As described above, in the embodiment of the present invention, sufficient amount of heat energy for fuel reforming reaction is produced in the exothermic reaction. Thus, no external heating mechanism is required, and the overall structure of the fuel gas production apparatus is simple. The time required for warming up the fuel gas production system 10 using the auto-thermal reforming system is short in contrast to the production system using the steam reforming system. Thus, the operation of the fuel cell stack can be started rapidly.

In the embodiment of the present invention, the reforming mechanism 20 uses the auto-thermal reforming system. Therefore, it is possible to reduce the CO concentration in the reformer 30 in contrast to the reforming mechanism using the steam reforming system.

An experiment was conducted for detecting gas components discharged from the reformer 30 in each of the case in which the reforming mechanism 20 using the auto-thermal reforming system according to the embodiment of the present invention is used, and the case in which the reforming mechanism (not shown) using the steam reforming system is used. The experiment was conducted at a pressure of 30 kPa, methane SV (space velocity determined by gas flow rate/catalyst volume) of 8000 (1/hr), and S/C (steam carbon ratio) of 3.0, i.e. (CH₄:H₂O=1:3). The reaction temperature was 700°.

The result of the experiment is shown in the following Table.

TABLE 1

| GAS | STEAM REFORMING | AUTO-THERMAL |
|---|---|---|
| COMPONENT | (%) | REFORMING (%) |
| CO | 14.0 | 7.2 |
| CO₂ | 13.5 | 11.0 |
| H₂ | 68.4 | 48.5 |
| CH₄ | 4.1 | 2.9 |
| N₂ | — | 30.4 |

According to the experiment, in the auto-thermal reforming system (embodiment of the present invention), CO concentration in the gas components discharged from the reforming mechanism 20 is about the half of the CO concentration in the steam reforming system. Thus, even if the reformed gas is not subjected to the CO shift reaction, a small PSA mechanism 24 can be used efficiently.

The conventional high temperature shifting reactor is not required. The simple can compact PSA mechanism 24 can be used e-fficiently for inducing the desired reforming reaction rapidly. The hydrogen-rich pure fuel gas can be produced efficiently.

Since the high temperature shift reactor is not required, the size of the fuel gas production apparatus 10 is small, and the overall structure of the fuel gas production apparatus 10 is simple. The fuel cell can be produced at a low cost. In particular, at the time of starting the operation of the fuel cell stack 16, or stopping the operation of the fuel cell stack 16, inert gases such as nitrogen or water vapor are not required. For example, at the time of starting the operation of the fuel cell stack 16, the combustion gas is supplied directly to the reforming mechanism 20 for rapidly warming up the fuel cell stack 16. When the operation of the fuel cell is stopped, hot gas is purged by the air. Thus, the operation of the fuel cell can be started in a short period of time with a small energy.

After the reformer 30 reforms the gas, the reformed gas is cooled to a predetermined temperature by the cooling mechanism 22, and the cooled gas is supplied to the PSA mechanism 24. Specifically, the reformed gas from the reformer 30 has a high temperature of about 700°. The reformed gas is cooled to a temperature of about 40° by the cooling mechanism 22, and supplied to the PSA mechanism 24. Thus, in the cooling mechanism 22, the temperature of the reformed gas changes significantly. A relatively large amount of heat energy (waste heat) is generated by the heat exchange. The heat energy is utilized to effectively perform cogeneration in the fuel cell system 12, for example.

When the reformed gas is supplied to the PSA mechanism 24, the reformed gas is selectively supplied to the adsorption towers 34, 36, and 38 through the compressor 32. The PSA mechanism 24 absorbs impurities in the adsorption tower 34, reduce the pressure in the adsorption tower 36, and purges the waste gas in the adsorption tower 38. Thus, the components other than hydrogen is absorbed in the adsorption tower 34, and a hydrogen-rich pure fuel gas (fuel gas having high concentration of hydrogen) is supplied to the fuel gas flow field 64 of each of the fuel cells 50.

After the absorbing step in the adsorption tower 34, and the pressure equalization step in the adsorption tower 36 and the adsorption tower 38 are performed, The absorbing step in the adsorption tower 34, blowing down step in the adsorption tower 36, and the pressure increasing step in the adsorption tower 38 are performed. The off gas discharged from the adsorption tower 36 is supplied to the off gas tank 42. The off gas in the off gas tank 42 is used as a fuel in the combustor 28.

As described above, in the adsorption tower 34, 36, 38, the series of operations, i.e., adsorption of the impurities, reduction of pressure, purge of waste gas, and blowing down are selectively performed to produce the hydrogen-rich pure fuel gas, and the fuel gas is supplied to the fuel gas flow field 64 in each of the fuel cells 50 of the fuel cell stack 16. Further, the air blower 14 is used to supply the air to the oxygen-containing gas flow field in each of the fuel cell 50 of the fuel cell stack 16.

In the membrane electrode assembly 52, the oxygen-containing gas supplied to the cathode 60, and the fuel gas supplied to the anode 62 are consumed in the electrochemical reactions at catalyst layers of the cathode 60 and the anode 62 for generating electricity. After the oxygen in the air is partially consumed at the cathode 62, the air is supplied to the combustor 28 as necessary.

According to the present invention, a fuel, a water vapor (steam), and oxygen are supplied to the reforming mechanism. Oxidation reaction and fuel reforming reactions are carried out simultaneously using the auto-thermal reforming system. No external heating mechanisms are required. Thus, the fuel gas production apparatus has a simple structure. The auto-thermal system is suitable for warming up the fuel cell stack in a short period of time in comparison with the steam reforming system.

Even though the CO shift reaction of the reformed gas is not carried out, it is possible to use a small PSA mechanism. Consequently, no high temperature shift reactor is required. With the simple and compact PSA mechanism, the desired reforming reaction can be carried out effectively, and the hydrogen-rich pure gas can be produced efficiently.

While the invention has been particularly shown and described with reference to preferred embodiments, it will be understood that variations and modifications can be effected thereto by those skilled in the art without departing from the spirit and scope of the invention as defined by the appended claims.

1. A fuel gas production apparatus for reforming a hydrogen-containing fuel to produce a hydrogen-rich fuel gas, comprising:
a reforming mechanism for reforming the hydrogen-containing fuel to obtain a reformed gas;
a PSA mechanism directly connected to said reforming mechanism for removing impurities from said reformed gas to refine said reformed gas into said fuel gas,
wherein said reforming mechanism uses said hydrogen containing fuel, steam and oxygen to induce oxidation reaction and reforming reaction simultaneously.

2. A fuel gas production apparatus according to claim 1, further comprising a cooling mechanism provided between said reforming mechanism and said PSA mechanism.

3. A fuel gas production apparatus according to claim 1, wherein said hydrogen-containing fuel is methane.

4. A fuel cell system comprising:
a fuel gas production apparatus for reforming a hydrogen-containing fuel to produce a hydrogen rich fuel gas; and
a fuel cell using said fuel gas supplied from said fuel gas production apparatus,
wherein said fuel gas production apparatus comprises:
a reforming mechanism for reforming the hydrogen-containing fuel to obtain a reformed gas; and
a PSA mechanism directly connected to said reforming mechanism for removing impurities from said reformed gas to refine said reformed gas into said fuel gas,
wherein said reforming mechanism uses said hydrogen containing fuel, steam and oxygen to induce oxidation reaction and reforming reaction simultaneously.

5. A fuel cell system according to claim 4, further comprising a cooling mechanism provided between said reforming mechanism and said PSA mechanism.

6. A fuel cell system according to claim 4, wherein said hydrogen-containing gas is methane.

7. A fuel cell system according to claim 4, further comprising an air blower for supplying air to said fuel cell.
